(19) United States
(12) Patent Application Publication
(10) Pub. No.: US 2012/0285049 A1
(43) Pub. Date: Nov. 15, 2012

(54) HYDRAULIC BUCKET APPARATUS

(75) Inventors: Michael MIRE, Kenner, LA (US); Joey NAQUIN, Houma, LA (US)

(73) Assignee: GULFSTREAM SERVICES, INC., Houma, LA (US)

(21) Appl. No.: 13/445,413

(22) Filed: Apr. 12, 2012

Related U.S. Application Data
(60) Provisional application No. 61/474,623, filed on Apr. 12, 2011.

(51) Int. Cl. B66C 3/02

(52) U.S. Cl. 37/186

(57) ABSTRACT

A hydraulic clamshell bucket apparatus employs a frame that includes an upper lifting member that enables the frame to be lifted with a crane or other lifting device. First and second hydraulically powered jaws and jaw pivots are provided on the frame. First and second hydraulic cylinders pivot on the frame above the jaw pivots, each cylinder connected to the frame at an upper cylinder pivot. Each cylinder pivotally attaches to a jaw at a lower cylinder pivot. Each jaw has a concave surface. First and second digging implements are attached to the jaws. Each digging implement has a concave portion. Each digging implement is wider than the jaw to which it is attached so that each implement extends laterally away from the jaw to which it is attached. A pair of side panels is attached to each digging implement at positions spaced away from the jaws.

### CROSS-REFERENCE TO RELATED APPLICATIONS

This is a nonprovisional patent application of U.S. Provisional Patent Application Ser. No. 61/474,623, filed 12 Apr. 2011, which is hereby incorporated herein by reference.

Priority of U.S. Provisional Patent Application Ser. No. 61/474,623, filed 12 Apr. 2011, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to a method and apparatus for excavating dense clay material in a marine environment.

2. General Background of the Invention

Plug and abandonment of an oil well typically utilizes cold cutting of the sections of tubulars as they are removed from the well. This cold cutting is done with a saw. Another method of cutting tubulars that are being removed from an oil well is to manually cut with a cutting torch. However, such use of cutting torches can generate injury or death if a pocket of natural gas is trapped in between layers of casing or tubing. Such a pocket of gas can be ignited by the open flame of a cutting torch, generating an explosion. The cutting and removal of sections of tubular production pipe, production casing or the like from an oil well also requires removal of part of the marine sediment, which can be a very dense clay material that is not easily removed. At times, the only effective way to remove such bottom sediment is with an underwater cutting device operated by a diver.

### BRIEF SUMMARY OF THE INVENTION

The present invention provides a hydraulic clamshell bucket apparatus having a frame that includes an upper lifting member that enables the frame to be lifted with a crane or other lifting device.

First and second hydraulically powered jaws are supported below the frame, each jaw pivotally attached to the frame.

Upper frame pivots are provided on the frame, each jaw pivotally attached to the frame at a said frame pivot.

First and second hydraulic cylinders are provided, each pivotally connected to the frame.

Cylinder pivots on the frame are provided above the jaw pivots, each cylinder connected to the frame at a cylinder pivot.

Lower cylinder pivots are provided on the jaws, each cylinder pivotally attached to a jaw at a lower cylinder pivot.

Each jaw can have a concave surface and a flat surface.

First and second digging implements are attached to the jaws. The first digging implement is attached to the first jaw. The second digging implement is attached to the second jaw.

Each digging implement has concave portions. Each digging implement extends laterally away from the jaws.

Side panels are attached to the digging implement at positions spaced away from the jaws.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a partial perspective view of a preferred embodiment of the apparatus of the present invention;

FIG. 2 is a partial perspective view of a preferred embodiment of the apparatus of the present invention;

FIG. 3 is a sectional view taken along lines 3-3 of FIG. 1;

FIG. 4 is a sectional view taken along lines 3-3 of FIG. 1;

FIG. 5 is a perspective view of a preferred embodiment of the apparatus of the present invention;

FIG. 6 is a perspective view of a preferred embodiment of the apparatus of the present invention;

FIG. 7 is an elevation view of a preferred embodiment of the apparatus of the present invention;

FIG. 8 is an elevation view of a preferred embodiment of the apparatus of the present invention showing the apparatus as it engages a sea bed;

FIG. 9 is an elevation view of a preferred embodiment of the apparatus of the present invention showing a removal of material from a sea bed;

FIG. 10 is an elevation view of a preferred embodiment of the apparatus of the present invention showing a removal of material from a sea bed;

FIG. 11 is a perspective view of a preferred embodiment of the apparatus of the present invention;

FIG. 12 is a perspective view of a preferred embodiment of the apparatus of the present invention;

FIG. 13 is a perspective view of a preferred embodiment of the apparatus of the present invention;

FIG. 14 is a side sectional view of a preferred embodiment of the apparatus of the present invention with jaws closed; and

FIG. 15 is a side sectional view of a preferred embodiment of the apparatus of the present invention with jaws opened.

### DETAILED DESCRIPTION OF THE INVENTION

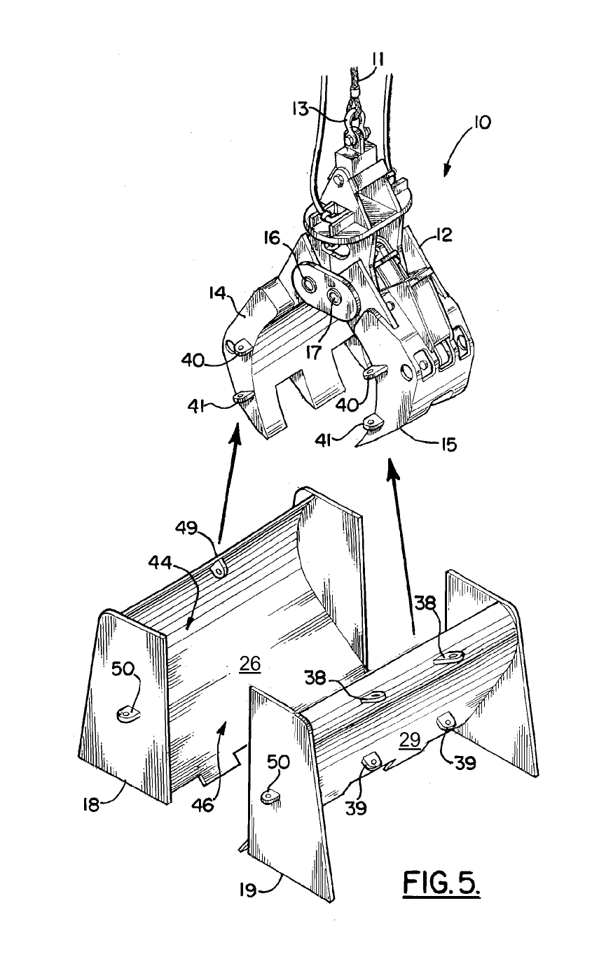

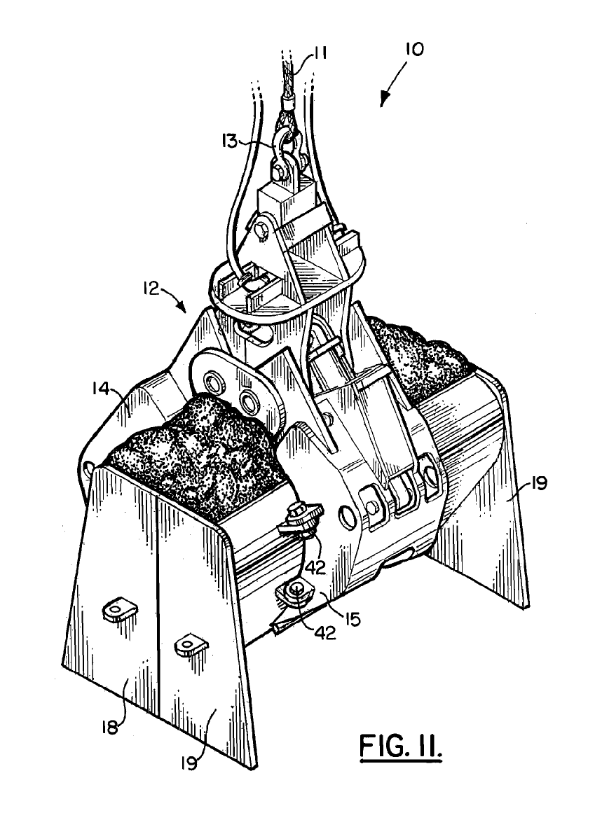

FIGS. 5-15 show a preferred embodiment of the apparatus of the present invention, designated generally by the numeral 10. Hydraulic clamshell bucket 10 can be moved into position for work using a lifting line or a sling 11. The lifting line or sling 11 can form a connection with the hydraulic clamshell bucket 10 body 12 at shackle 13.

As shown in FIG. 5, the body or frame 12 supports a pair of hydraulically powered jaws 14, 15. Each jaw 14, 15 has a pivot or pivotal attachment to body 12. Jaw 14 has a pivotal attachment to body 12 at pivot 16. Jaw 15 has a pivotal attachment to body 12 at pivot 17.

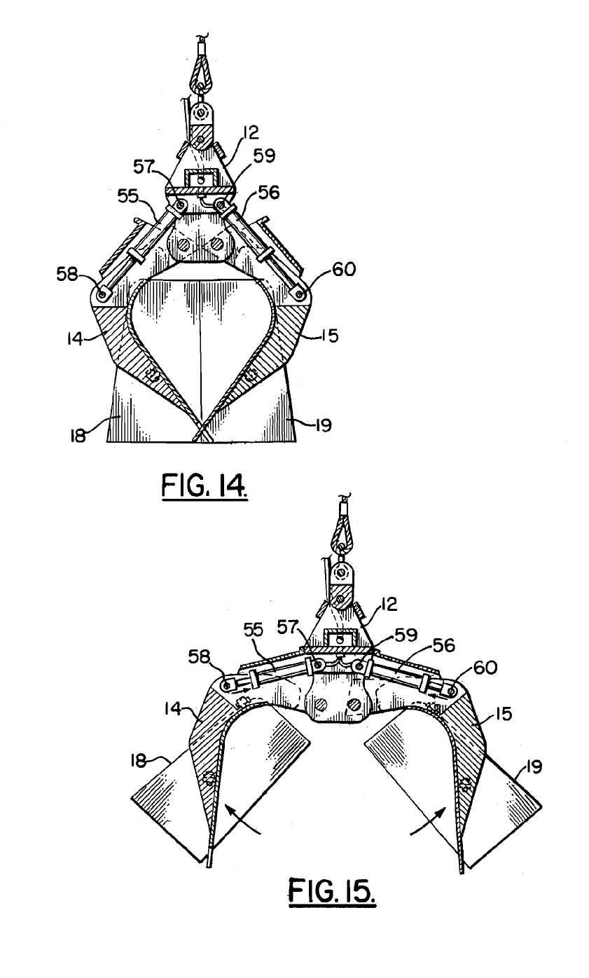

FIGS. 14 and 15 show a first extensible hydraulic cylinder 55 that is attached to frame 12 and to jaw 14. A second extensible hydraulic cylinder 56 is attached to frame 12 and to jaw 15. The cylinder 55 has upper cylinder pivot (or pivotal connection) 57 wherein jaw 14 attaches to frame 12 and lower cylinder pivot 58 where cylinder 55 attaches to jaw 14. Similarly, cylinder 56 has upper cylinder pivot 59 where cylinder 56 attaches to frame 12 and lower cylinder pivot 60 where cylinder 56 attaches to jaw 15.

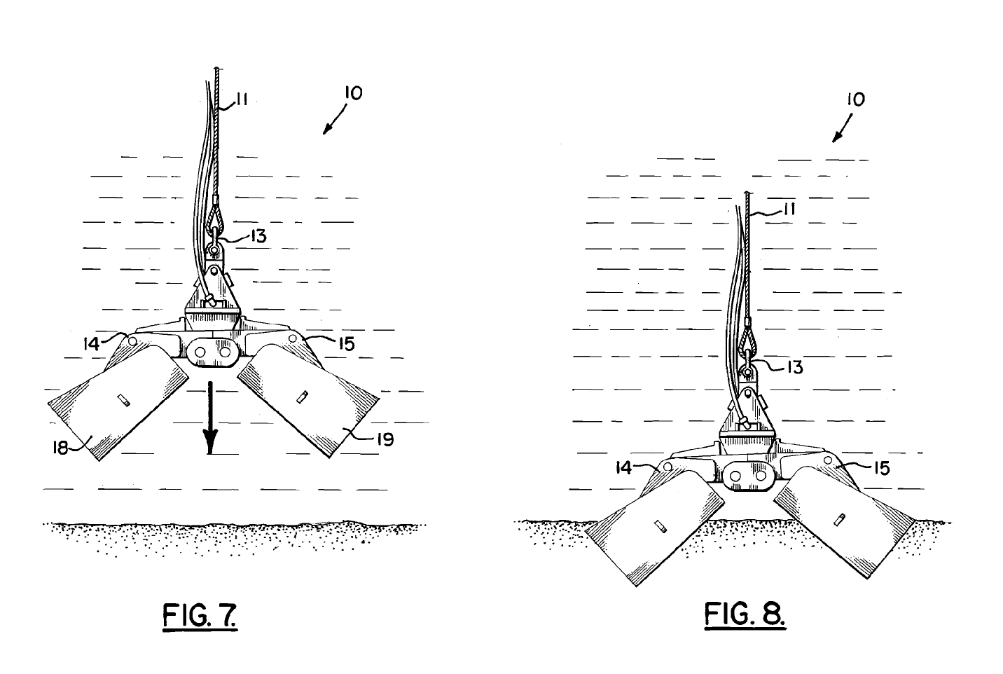

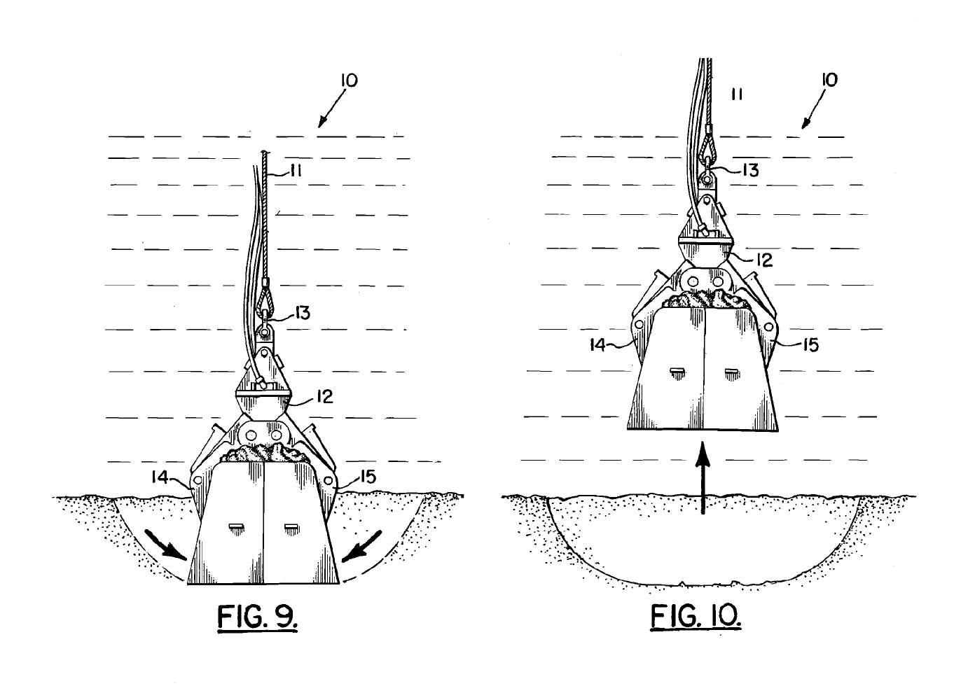

When cylinders 55, 56 retract, the jaws 14, 15 open to the position of FIGS. 7, 8, and 15. When the cylinders 55, 56 extend, the jaws 14, 15 close to the position of FIGS. 9-14.

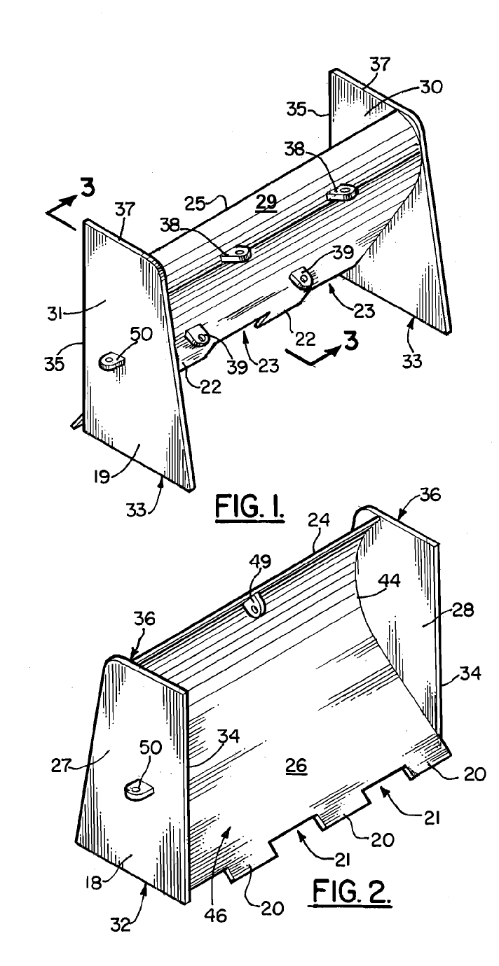

A digging implement or bucket half 18, 19 is provided for attachment to each jaw 14, 15. Each bucket half has teeth 20, 22 and recesses 21, 23 in between teeth as shown in FIGS. 1 and 2. Each digging implement or bucket half 18, 19 has recesses in between the teeth. Recesses 21 are provided in between teeth 20. Recesses 23 are provided in between teeth 22.

Each implement 18, 19 has an upper edge. The implement or bucket half 18 has upper edge 24. The implement or bucket half 19 has upper edge 25.

Each digging implement or bucket half 18, 19 has a blade. The implement 18 has blade 26 with side panels 27, 28. The implement 19 has blade 29 with side panels 30, 31.

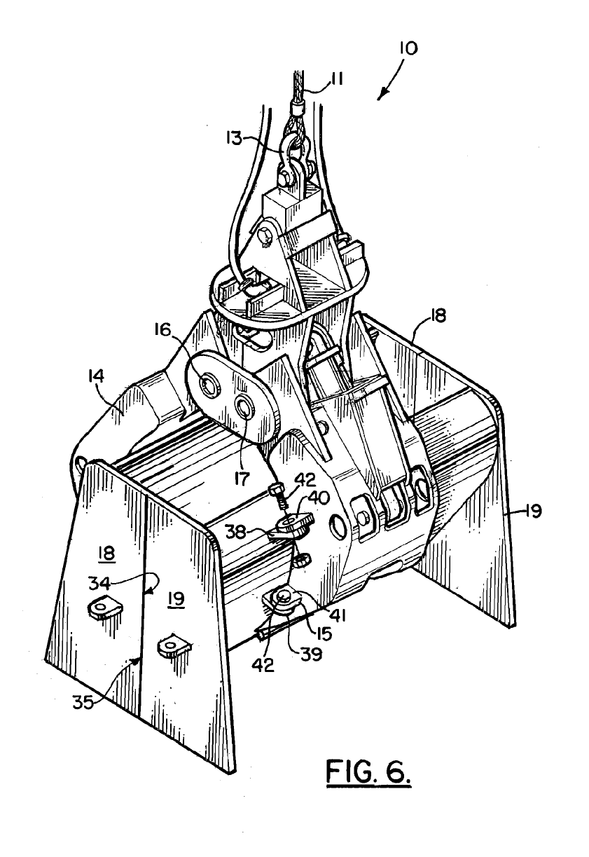

Each of the side panels 27, 28 and 30, 31 has a bottom edge. For the implement 18, each of the side panels 27, 28 provides bottom edges 32. For the implement 19, each of the side panels 30, 31 have bottom edges 33. Each of the side panels 27, 28 and 30, 31 provides inner edges. The side panels 27, 28 have inner edges 34. The side panels 30, 31 each have an inner edge 35. During use, the edges 34, 35 engage and abut when the apparatus 10 is in a closed position as shown in FIG. 6.

Each of the side panels have upper edges. The side panels 27, 28 have upper edges 36. The side panels 30, 31 each have upper edges 37. A plurality of padeyes or lugs are provided on each of the implements 18, 19. These lugs include upper lugs or padeyes 38 and lower lugs or padeyes 39 as shown in FIG. 1. Each of the jaws 14, 15 of the body or frame 12 has a plurality of lugs or padeyes 40, 41. These include upper lugs or padeyes 40 and lower lugs or padeyes 41 as shown in FIG. 5. Bolted connections are used to assemble the lugs or padeyes of the jaws 14, 15 with the lugs or padeyes of the implements 18, 19. Bolted connections 42 can be used to connect a lug or padeye of a jaw 14 or 15 to a lug or padeye of an implement 18 or 19 (see FIG. 6).

The upper and lower lugs or padeyes 40, 41 on the jaws 14, 15 can be seen in FIGS. 4-6. Arrows 43 in FIG. 4 illustrate the attachment of the lugs 40, 41 to the jaws 14, 15. This attachment can be a welded attachment for example. The lugs or padeyes 38, 39 on the implements 18, 19 can be seen in FIGS. 1-3, 5, and 6.

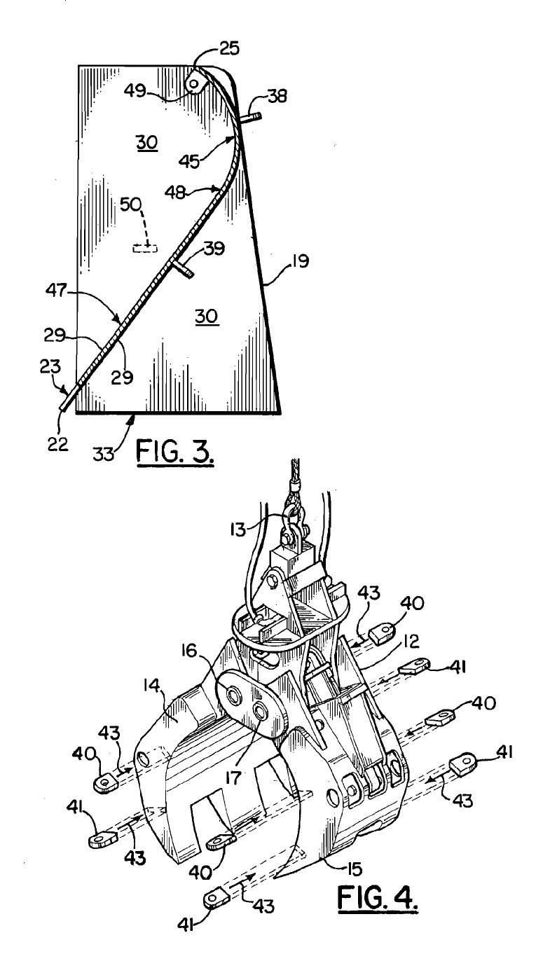

Each implement 18, 19 has blades 26, 29. Each blade 26, 29 has concave and flat surfaces. For the implement 18, the blade 26 has concave surface 44 and flat surface 46, as shown in FIG. 5. For the implement 19, the blade 29 has concave surface 45 and flat surface 47, as shown in FIG. 3. For each of the implements 18, 19 the location 48 shows the joint between its concave surface and its flat surface. For example, in FIG. 3, the concave surface 45 meets the flat surface 47 at location 48.

Each implement 18, 19 has a lifting eye 49. The lifting eye 49 is attached to the concave 44 surface of blade 26 of implement 18 as shown in FIG. 5 and at concave surface 45 of blade 25 of implement 19 as shown in FIG. 3. The lifting eye 49 can be at a position next to upper edge 25 as shown in FIG. 3.

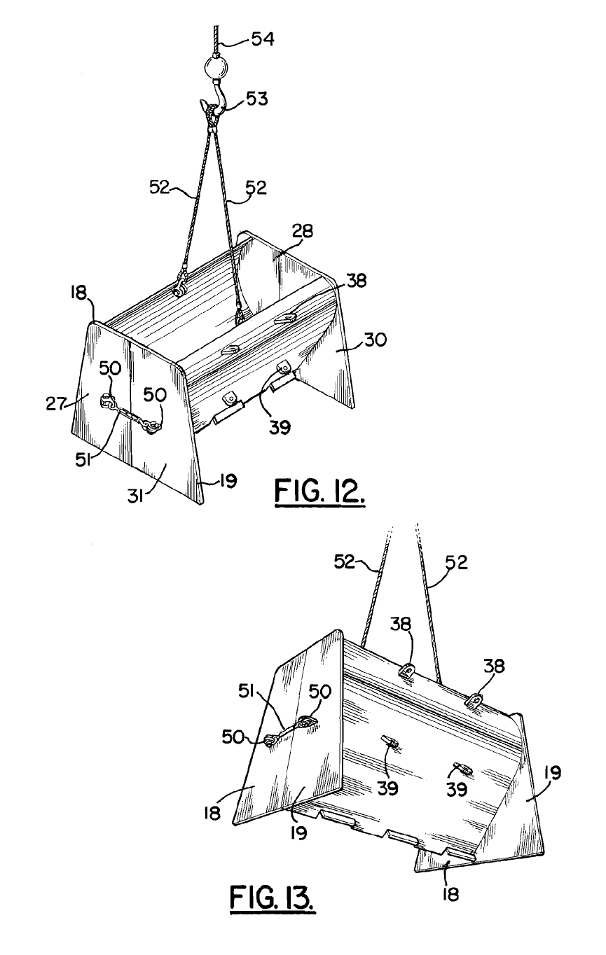

Each implement 18, 19 has a padeye or lug 50 on each of its side panels 27, 28, 30, 31 as shown in FIGS. 1, 2, 3 and 12-13. When it is desired to handle the implements 18, 19 before or after they have been assembled to the body or frame 12, the implements 18, 19 can be joined together using slings 51 wherein the sling 51 is attached to the padeyes 50 of the side panels 27, 28, 30, 31 as shown in FIGS. 12 and 13. This assembly of implements 18, 19 can be lifted using lift lines or slings 52 attached to a hook 53 of a crane lifting line 54.

The following is a list of parts and materials suitable for use in the present invention:

PARTS LIST

| Parts Number | Description |
|---|---|
| 10 | hydraulic clamshell bucket |
| 11 | lifting line/sling |
| 12 | body/frame |
| 13 | shackle |
| 14 | jaw |
| 15 | jaw |
| 16 | pivot |
| 17 | pivot |
| 18 | bucket half/implement |
| 19 | bucket half/implement |
| 20 | tooth |
| 21 | recess |
| 22 | tooth |
| 23 | recess |
| 24 | upper edge |
| 25 | upper edge |
| 26 | blade |
| 27 | side panel |
| 28 | side panel |
| 29 | blade |
| 30 | side panel |
| 31 | side panel |
| 32 | bottom edge |
| 33 | bottom edge |
| 34 | inner edge |
| 35 | inner edge |
| 36 | upper edge |
| 37 | upper edge |
| 38 | upper lug/padeye |
| 39 | lower lug/padeye |
| 40 | upper lug/padeye |
| 41 | lower lug/padeye |
| 42 | bolted connection |
| 43 | arrow |
| 44 | concave surface |
| 45 | concave surface |
| 46 | flat surface |
| 47 | flat surface |
| 48 | location |
| 49 | lifting eye |
| 50 | padeye/lug |
| 51 | sling |
| 52 | lift line/sling |
| 53 | hook |
| 54 | lift line |
| 55 | first hydraulic cylinder |
| 56 | second hydraulic cylinder |
| 57 | upper cylinder pivot/pivotal |
| | connection |
| 58 | lower cylinder pivot/pivotal |
| | connection |
| 59 | upper cylinder pivot/pivotal |
| | connection |
| 60 | lower cylinder pivot/pivotal |
| | connection |

All measurements disclosed herein are at standard temperature and pressure, at sea level on Earth, unless indicated otherwise.

The foregoing embodiments are presented by way of example only; the scope of the present invention is to be limited only by the following claims.

1. A hydraulic clamshell bucket apparatus, comprising:
a) a frame that includes an upper lifting member that enables the frame to be lifted with a crane or other lifting device;
b) first and second hydraulically powered jaws, each jaw pivotally attached to the frame at provided jaw pivots and in a plane of jaw movement;
c) first and second hydraulic cylinders, each cylinder connected to the frame;
d) upper cylinder pivots on the frame above the jaw pivots, each cylinder connected to the frame at an upper cylinder pivot;
e) lower cylinder pivots on the jaws, each cylinder pivotally attached to a jaw at a lower cylinder pivot;
f) each jaw having a concave surface;
g) first and second digging implements attached to the jaws, the first digging implement attached to the first jaw, the second digging implement attached to the second jaw;
h) each digging implement having concave portions, each digging implement extending laterally away from the jaws; and
i) side panels attached to the digging implement at positions spaced away from the jaws, said side panels generally parallel with the said plane of jaw movement.

2. The hydraulic clamshell bucket apparatus of claim 1 wherein the side panels of each implement are parallel.

3. The hydraulic clamshell bucket apparatus of claim wherein the side panels have generally horizontal surfaces.

4. The hydraulic clamshell bucket apparatus of claim 1 wherein each implement is removably attached to a said jaw.

5. The hydraulic clamshell bucket apparatus of claim 4 wherein each implement is bolted to a said jaw.

6. The hydraulic clamshell bucket apparatus of claim 1 wherein there are connections that connect each implement to a said jaw, said connections being in between said side panels.

7. The hydraulic clamshell bucket apparatus of claim 1 wherein each implement has a flat surface portion.

8. The hydraulic clamshell bucket apparatus of claim 1 wherein each implement has a toothed portion.

9. The hydraulic clamshell bucket apparatus of claim 8 wherein each side panel has a lower surface that extends horizontally to the rear of the toothed portion of a said implement.

10. A hydraulic clamshell bucket apparatus, comprising:
a) a frame;
b) first and second hydraulically powered jaws, each jaw attached to the frame at provided jaw pivots;
c) first and second hydraulic cylinders, each cylinder connected to the frame;
d) upper cylinder pivots on the frame above the jaw pivots, each cylinder connected to the frame at an upper cylinder pivot;
e) lower cylinder pivots on the jaws, each cylinder pivotally attached to a jaw at a lower cylinder pivot;
f) first and second digging implements attached to the jaws, the first digging implement attached to the first jaw, the second digging implement attached to the second jaw;
g) each digging implement having concave portions, each digging implement extending laterally away from the jaws in two directions; and
h) a plurality of four side panels attached to the digging implement, one side panel attached to each digging implement at positions spaced away from the jaws and on opposing sides of each digging implement.

11. A hydraulic clamshell bucket apparatus, comprising:
a) a frame that includes an upper lifting portion that enables the frame to be lifted with a crane or other lifting device;
b) first and second hydraulically powered jaws, each jaw pivotally attached to the frame at provided jaw pivots;
c) each jaw having a concave surface;
d) first and second digging implements attached to the jaws, the first digging implement attached to the first jaw, the second digging implement attached to the second jaw;
e) each digging implement having concave portions, a pair of side edges, an upper edge, a lower edge, and each digging implement extending laterally away from the jaws;
f) side panels attached to the digging implement at positions spaced away from the jaws; and
g) wherein a said side edge is connected to a said side panel.

12. The hydraulic clamshell bucket apparatus of claim 11 wherein the side panels of each implement are parallel.

13. The hydraulic clamshell bucket apparatus of claim 11 wherein the side panels have generally horizontal surfaces.

14. The hydraulic clamshell bucket apparatus of claim 11 wherein each implement is removably attached to a said jaw.

15. The hydraulic clamshell bucket apparatus of claim 14 wherein each implement is bolted to a said jaw.

16. The hydraulic clamshell bucket apparatus of claim 11 wherein there are connections that connect each implement to a said jaw, said connections being in between said side panels.

17. The hydraulic clamshell bucket apparatus of claim 11 wherein each implement has a flat surface portion.

18. The hydraulic clamshell bucket apparatus of claim 11 wherein each implement has a toothed portion.

19. The hydraulic clamshell bucket apparatus of claim 18 wherein each side panel has a lower surface that extends horizontally to the rear of the toothed portion of a said implement.

20. A hydraulic clamshell bucket apparatus, comprising:
a) a frame;
b) first and second hydraulically powered jaws, each jaw movable between open and closed positions, said jaws attached to the frame at provided jaw pivots;
c) first and second hydraulic cylinders, each cylinder connected to the frame;
d) upper cylinder pivots on the frame above the jaw pivots, each cylinder connected to the frame at an upper cylinder pivot;
e) lower cylinder pivots on the jaws, each cylinder pivotally attached to a jaw at a lower cylinder pivot;
f) first and second digging implements attached to the jaws, the first digging implement attached to the first jaw, the second digging implement attached to the second jaw;
g) each digging implement having concave portions, a pair of side edges, an upper edge, a lower edge, and each digging implement extending laterally away from the jaws;
h) side panels attached to the digging implement at positions spaced away from the jaws;
i) first and second digging implements attached to the jaws, the first digging implement attached to the first jaw, the second digging implement attached to the second jaw; and
j) wherein the side panels of each pair of jaws have correspondingly shaped abutting edges that abut when the jaws move to the closed position.
